(19) United States
(12) Patent Application Publication
(10) Pub. No.: US 2015/0371426 A1
(43) Pub. Date: Dec. 24, 2015

(54) MOTION COVERS

(71) Applicant: Joshua Levy, Woodland Hills, CA (US)

(72) Inventor: Joshua Levy, Woodland Hills, CA (US)

(21) Appl. No.: 14/745,323

(22) Filed: Jun. 19, 2015

Related U.S. Application Data
(60) Provisional application No. 62/015,207, filed on Jun. 20, 2014.

(51) Int. Cl. G06T 13/80; G09G 5/12

(52) U.S. Cl. CPC G06T 13/80; G09G 5/12

(57) ABSTRACT

In one embodiment, a method comprising by one or more computing devices, receiving, from an another computing device, a resulting media signal file comprising a first portion of a media signal file comprising an audio track, and a second portion of an another media signal file comprising one or more frames of a graphic art image, extracting and displaying the second portion of the resulting media signal file, wherein the one or more frames of the graphic art image stream in a first sequence and the one or more frames of the graphic art image appear to be moving.

### RELATED APPLICATIONS

This application claims the benefit, under 35 U.S.C. §119(e), of U.S. Provisional Application No. 62/015,207, filed Jun. 20, 2014, which is incorporated herein by reference in its entirety for all purposes.

### TECHNICAL FIELD

This disclosure generally relates to movie, music, book, and video game cover art, and more specifically relates to digital and durable forms of movie, music, book, and video game cover art.

### BACKGROUND

An album cover is the front of the packaging of commercially released audio recording product, such as album, CD, digital download, and streaming music. The term album cover art may refer either to the printed cardboard cover that protects the media itself or the primary image accompanying a digital download of music as an album or its individual tracks, books, movies, or video games. Although the purpose and prevalence of the album cover art is evolving, cover art is still considered a vital part of the media experience to many.

Cover art is an artwork with a primarily commercial function, to promote the product on which it is displayed. Cover art may also have an aesthetic function, and may be artistically connected to the production, such as with art by the creator of the product.

### BRIEF DESCRIPTION OF THE DRAWINGS

FIG. 1A illustrates an example digital cover art of albums.

FIG. 1B illustrates an example digital cover art of movies.

FIG. 2 illustrates an example method.

FIG. 3 illustrates an example motion cover art.

FIG. 4 illustrates another example motion cover art.

FIG. 5 illustrates an example online store front with motion cover art.

FIG. 6 illustrates another example online store front with motion cover art.

FIG. 7 illustrates an example motion cover art during playback of a digital song.

FIG. 8 illustrates an example physical embodiment of an album with motion cover art.

FIG. 9 illustrates an example physical embodiment of a CD with motion cover art.

FIG. 10 illustrates an example computer system.

FIG. 11 illustrates an example network.

### DESCRIPTION OF EXAMPLE EMBODIMENTS

The present disclosure is now described in detail with reference to a few embodiments thereof as illustrated in the accompanying drawings. In the following description, numerous specific details are set forth in order to provide a thorough understanding of the present disclosure. However, the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to apply to alternatives, modifications, and equivalents as may be included within the spirit and scope of the disclosure as defined by the appended claims.

Early in the 20th Century, records were usually sold in brown paper or cardboard sleeves that were sometimes plain and sometimes printed to show the producer or retailer's name. Album covers and cover art began to gain popularity in the late 1930's because of efforts by Columbia Records and its first art director, Alex Steinweiss. By the late 1940's, album cover art was a mix of classic art and original designs. Throughout the years, album covers have become renowned for being a marketing tool and an expression of artistic intent.

Today, movies, music, books, and video games usually have original cover art associated with the respective movie, album, book, or video game. The cover art associated with movies, music, books, and video games may reside both on the actual durable goods that store the movie, album, or video game, or stored onto the non-transitory storage media comprising the movie, album, or video game, and on the actual durable good that comprises the book. The cover art associated with movies, music, books, and video games may also reside in digital form, stored on one or more computers either locally or over a network, and displayed to a user on a computer screen. Even as digital forms of cover art evolve, album cover art is still considered a vital part of the listening, viewing, and playing experience to many.

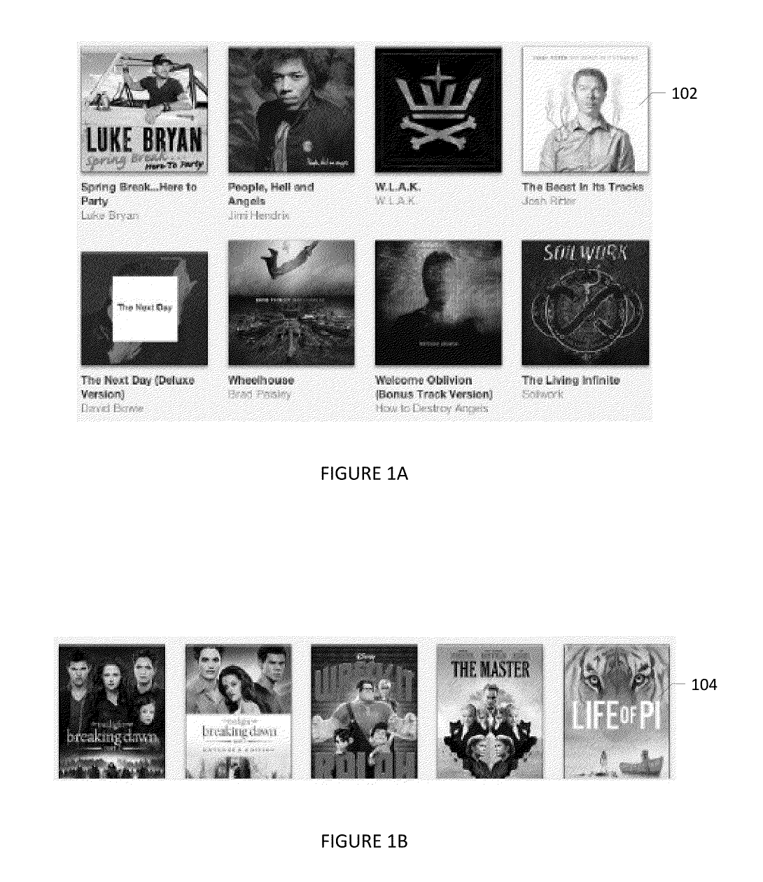

FIG. 1A illustrates example digital cover art of music albums, where image 102 is a displayed digital image of a graphic file having a graphic file format. FIG. 1B illustrates example digital cover art of movies, where image 104 is a displayed digital image of a graphic file having a graphic file format. Image 102 and image 104 in FIGS. 1A-B are still images for each product, a music album and movie, respectively. Including proprietary types of graphic file formats, there are hundreds of image file types. The PNG, JPEG, and GIF formats are most often used to display images on the internet. Additional graphic file formats are listed in Appendix 1.

A motion cover is moving album cover art, book cover art, video game cover art, or digital movie/DVD/BluRay cover art. As opposed to a traditional album, CD, book, video game, or DVD/BluRay cover art, a motion cover utilizes motion graphic, animation, or film and video techniques to make the image on the cover move. A motion cover may be associated with any digital audio, video, or image file platform, including but not limited to .mov, .m4v, .gif, and other similar file formats. Additional digital audio file formats are listed in Appendix 2. Additional video file formats are listed in Appendix 3. Motion cover may be software that encodes cover art displayed on computer that is animated.

A motion cover may be utilized by any digital music, book, video game and movie seller, streaming platforms, and any websites, including but not limited to, iTunes®, Amazon®, Spotify®. When a user buys or streams music, books, movies, or video games at an online store, a thumbnail image for the music, book, movie, or video game would be an animated motion cover instead of a still, stagnant image. When a user completes the purchase of a music, book, movie, or video game, and after downloading the music, book, movie, or video game, the motion cover would still be displayed. When a user runs or plays the music, book, movie, or video game, the motion cover would also be displayed. That is, even while a song was playing, the motion cover would be displayed.

When a user buys music, books, movies, or video games as durable, physical, tangible goods, the motion cover may be displayed on the durable, physical, tangible good, such as a CD, Book, DVD, video game, or album. A motion cover may be displayed on a thin-screen cover of music, books, movies, or video games. A motion cover may be displayed on a thin screen on any physical embodiment.

Motion cover art may be created for movies, albums, books, and video games. Motion cover art comprises moving images of various types, including but not limited to, .mov, .m4v, and .gif. A .gif is generally a small file, having about a 5 second loop, but may be of any file size or any length.

Particular embodiments of cover art comprise moving images for digital cover art of music albums, movies, books, and video games. Particular embodiments of cover art comprise moving images on thin screens and fabric screens for durable goods, such as the physical embodiments of the media storing the albums, movies, books, and video games.

Particular embodiments of cover art comprise moving images for digital cover art of music albums, individual songs, movies, books, and video games that is coupled with an audio file, where the moving images loop throughout the entire duration of playback of the audio file. While a song is playing, an image is a moving image, and is moving constantly throughout the song playing. The motion cover art may also be displayed as a moving image even when the song is not playing, such as the icon that is displayed for any of the various digital media described herein.

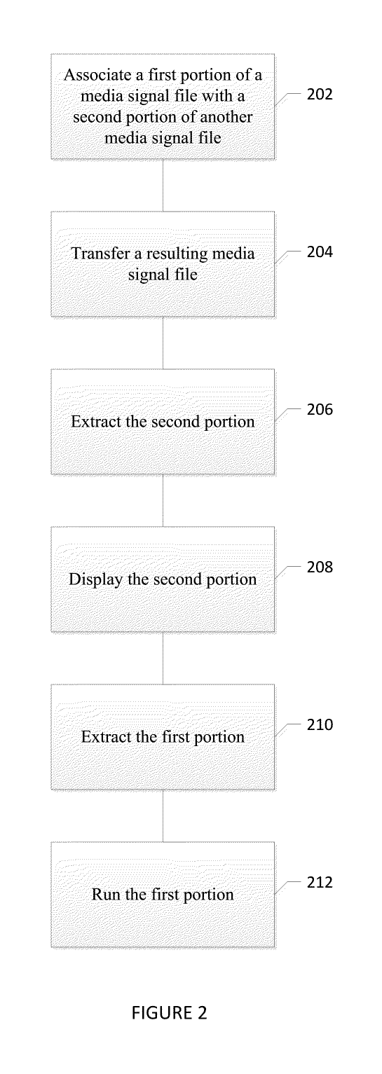

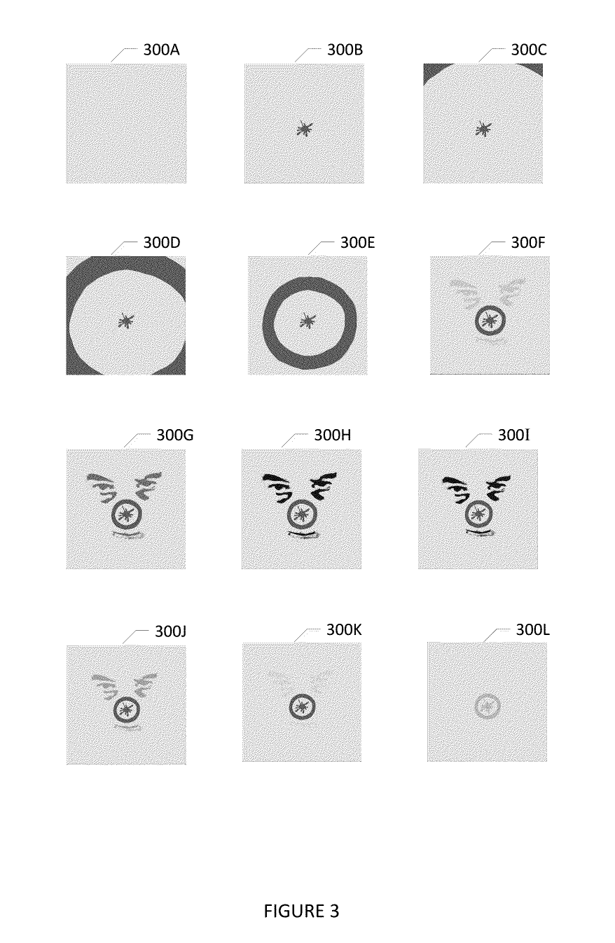

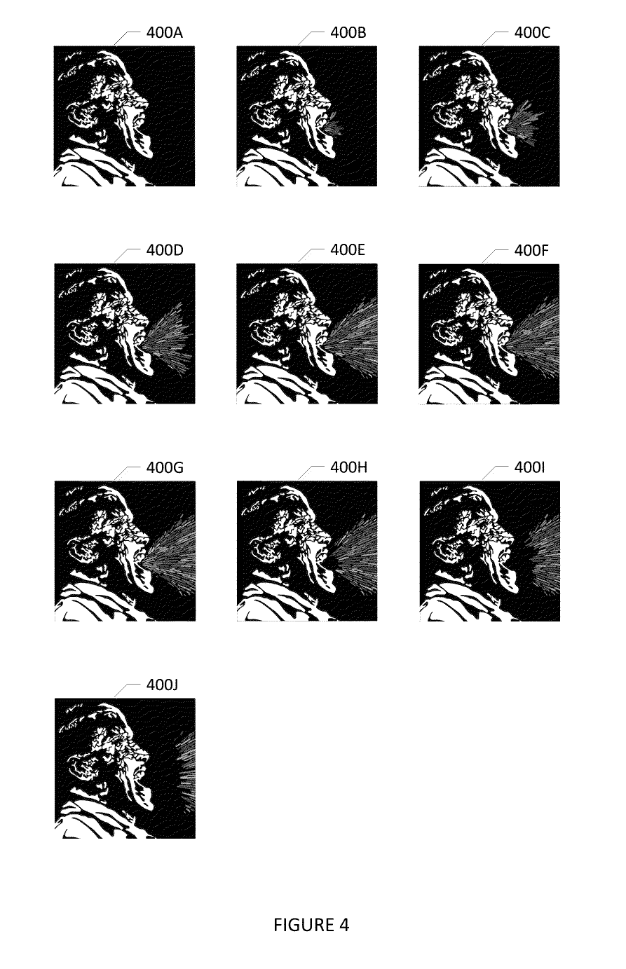

FIG. 2 illustrates an example method for displaying motion cover art. The method may start at step 202, where a first portion of a media signal file is associated with a second portion of another media signal file. In particular embodiments, a computing device, as described later in detail, may perform step 202. In particular embodiments, a media signal file may be a digital audio file, an image file, or a video file, of any of the file types described above or in Appendices 1-3. The first potion of a medial signal file may comprise audio, such as the audio within the file types described above and in Appendix 2. The second portion of the another media signal file may comprise one or more images, such as the images described below in FIGS. 3-4. Each image may comprise a single frame. In particular embodiments, the media signal file that results from the association of the first portion and the second portion comprises an audio track with a motion cover. In particular embodiments, the resulting media signal file comprises a single file type comprising both an audio file type and an image or video file type that may run and be displayed simultaneously. In particular embodiments, the resulting media signal file comprises a single file type comprising both an audio file type and an image or video file type there the image or video portion may be displayed when the audio portion is not playing.

In particular embodiments, a digital audio file of any audio file format, may have standardized metadata tags, or addressed locations in the file where specific information about the file is stored. Metadata comprises information about a digital audio file. In particular embodiments, metadata may be used to name, describe, catalog, and indicate ownership or copyright for a digital audio file. In particular embodiments, digital audio formats, including but not limited to .mp3, broadcast way, and AIFF files, may have similar standardized locations that can be populated with metadata.

In particular example embodiments, a second portion of the another media signal file comprises metadata that is associated with a first portion of the media signal file, such as an MP3 and AAC file. In particular example embodiments, a motion cover art may be embedded as metadata in an MP3 or AAC file. As will be described later, in particular embodiments, the motion cover art may be displayed. In particular embodiments, the motion cover art may be displayed on a software media player while the MP3 or AAC file are playing.

In particular embodiments, the resulting media signal file may be transferred, as illustrated in step 204. In particular embodiments, the resulting media signal file may be transferred from the first computing device onto a second computing device. In particular embodiments, the resulting media signal file may be transferred from the first computing device onto a computer readable non-transitory storage media. A computer readable non-transitory storage media will be described later in detail.

In particular embodiments, the second portion of the media signal file may be extracted, as illustrated in step 206. The extraction may be performed by any hardware or software, as described below, that the media signal file is compatible with.

FIG. 3 illustrates example images of a motion cover. In particular embodiments, a motion cover comprises one or more images 300A-300L that when streamed together, appear to be moving. Although images 300A-300L are illustrated as still images, images 300A-300L may be a video, image sequence, or multiple images that are directly to display in a particular order to appear as a moving image. In particular embodiments, images 300A-300L comprise individual image files having a size of an image enumerated in pixels, a color, such as best quality RGB (red-green-blue) mode, which includes black and white images, and a resolution enumerated in dots per inch (“DPI”). In particular example embodiments, images 300A-300L may each be perfectly square, at least 1600×1600 pixels, best quality RFB mode, and 300 DPI resolution.

In particular embodiments, images 300A-300L comprise images of a single image file. In particular embodiments, images 300A-300L each comprise individual frames of a video file. In particular embodiments, when images 300A-300L are streamed in a sequence, the resulting stream will appear to be moving. In particular embodiments, images 300A-300L may stream in order from 300A, 300B, 300C . . . 300L. In particular embodiments, images 300A-300L may stream out of order. In particular example embodiments, images 300A-300L may stream in a random order 300A, 300H, 300C . . . 300L.

FIG. 4 illustrates another example motion cover. As with FIG. 3, the motion cover illustrated in FIG. 4 comprises one or more images that when streamed together, appear to be moving. In particular embodiments, as with images 300A-300L of FIG. 3, images 400A-400J may comprise individual image files, individual frames of a video file, or a single image file. As described above with respect to FIG. 3, images 400A-400J may stream in order or out of order. In particular embodiments, when images 400A-400J stream, they appear to be moving.

In particular embodiments, the second portion may be displayed to a user, as illustrated in step 208. In particular embodiments one or more frames of the graphic art image may stream on the display. In particular embodiments, when the image is streaming, the graphic art may appear to be moving.

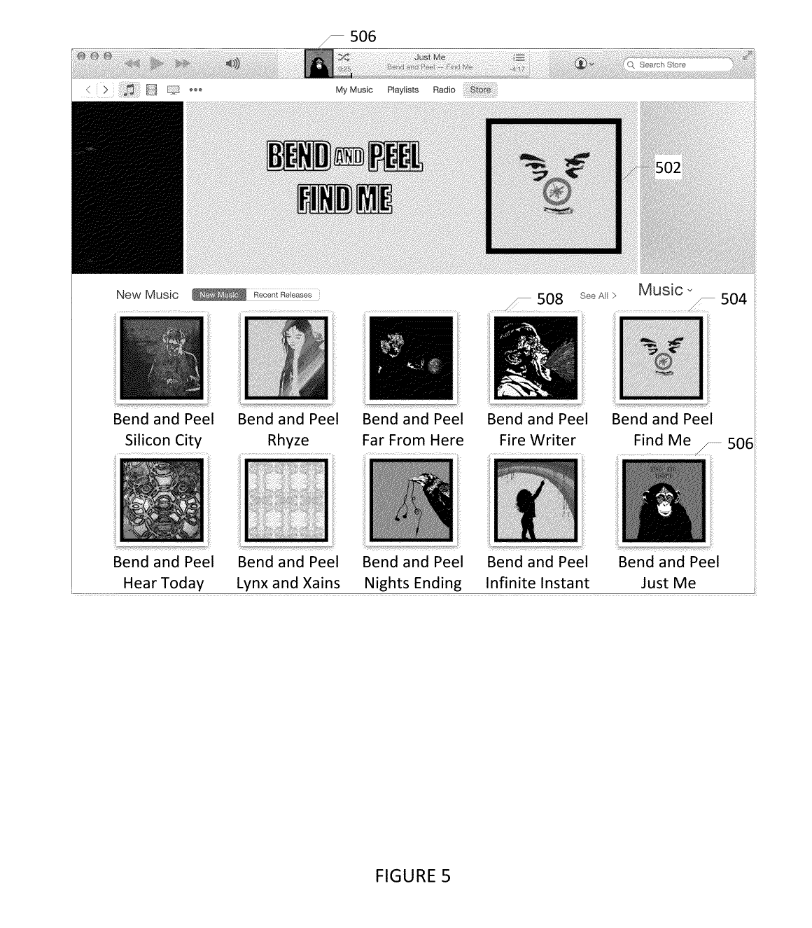

FIG. 5 illustrates an example online store front showing motion cover art of albums and songs. In particular embodiments, album cover 502, and song art 504, 506 comprise a motion cover. Although album cover 502 and song art 504, 506 appear to only be a single image, in particular embodiments, album cover 502 and song art 504, 506 comprise motion cover, such as the motion cover described in FIGS. 3-4 and above. In particular embodiments, when album cover 502 and song art 504, 506 are displayed as a streaming image, they may appear to be moving. In particular embodiments, album cover 502 and song art 504, 506 may be displayed as a still image until a user mouses-over an icon comprising album cover 502, or song art 504, 506, at which point album cover 502, song art 504, 506 may stream and appear to be moving.

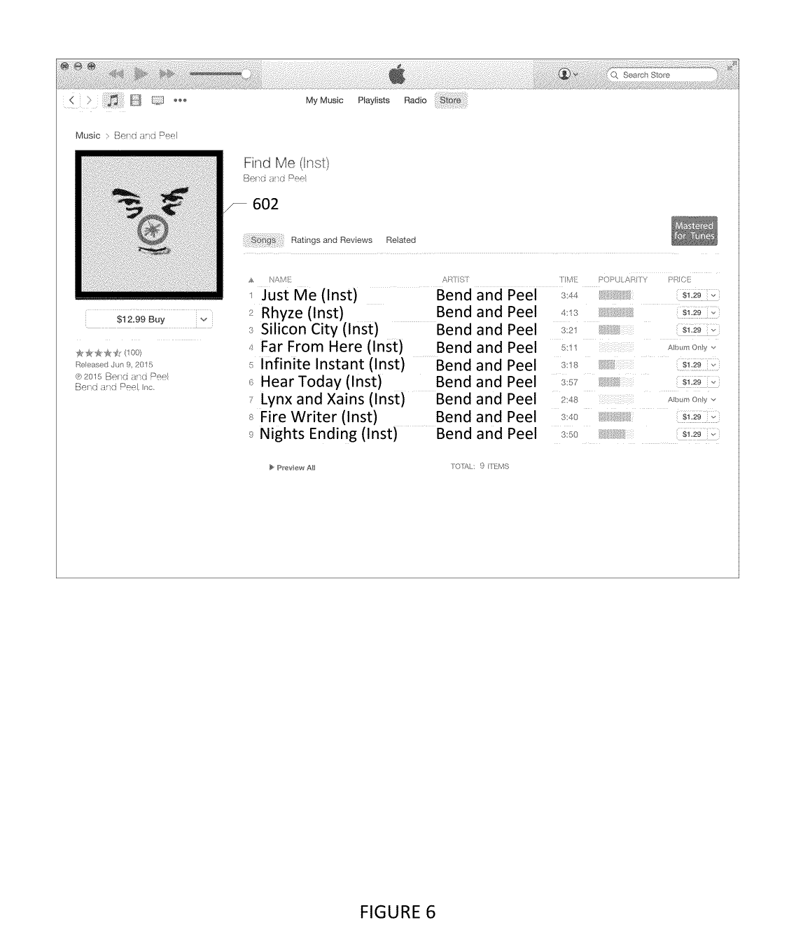

FIG. 6 illustrates another example online store front showing motion cover art of an album. In particular embodiments, album cover 602 comprises a motion cover. Although album cover 602 appears to be only a single, still image, in particular embodiments, album cover 602 comprises a motion cover, such as the motion cover described in FIGS. 3-4 and above. In particular embodiments, when album cover 602 is displayed, it is a streaming image that appears to be moving. In particular embodiments, album cover 602 may appear as a still image until a user mouses-over album cover 602, at which point album cover 602 begins streaming and appears to be moving.

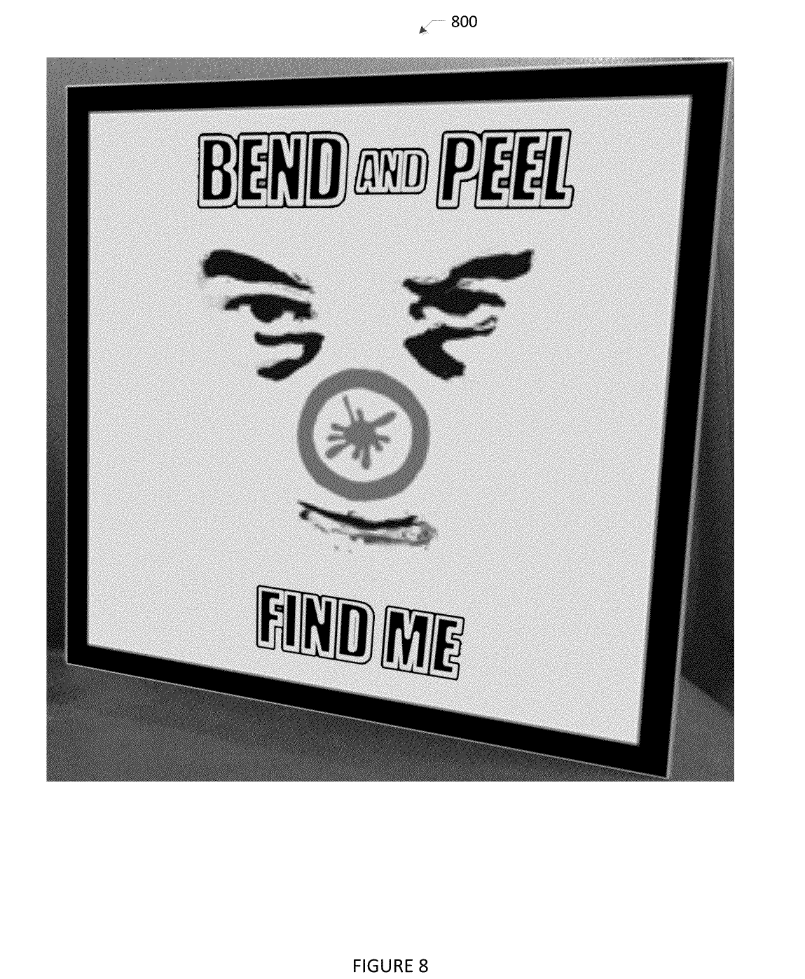

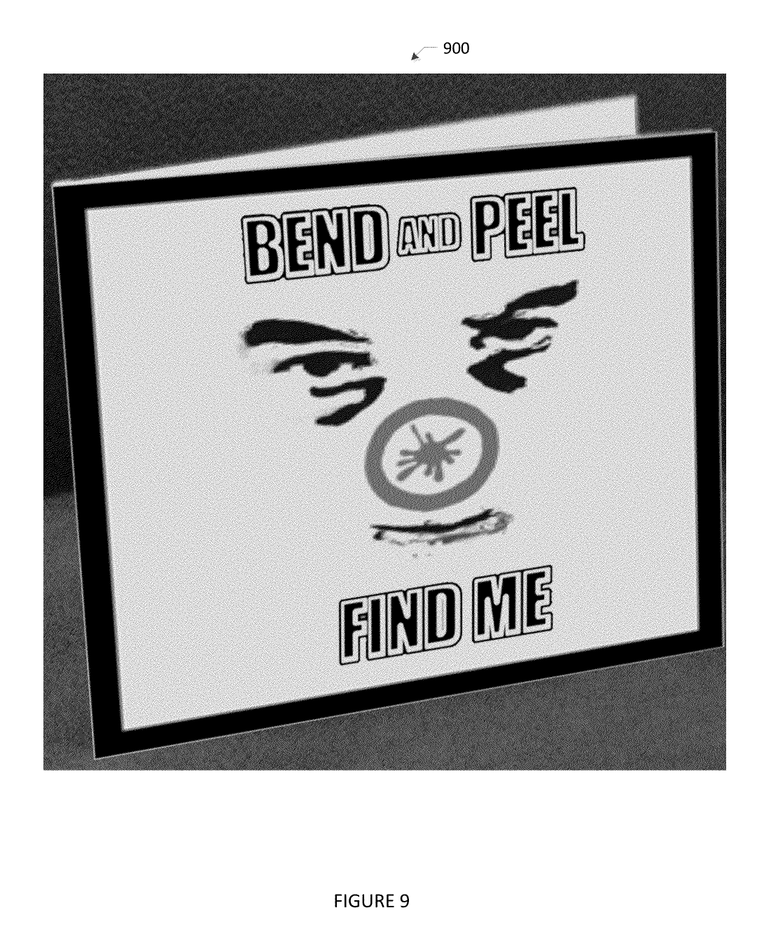

FIG. 8 illustrates an example physical embodiment of an album with motion cover art. Album 800 comprises a motion cover as described above, displayed on a physical good. FIG. 9 illustrates an example physical embodiment of a CD with motion cover art. CD cover 900 comprises a motion cover as described above, displayed on a physical good.

In particular embodiments, the first potion of the media signal file may be extracted, as illustrated in step 210. The extraction may be performed by any hardware or software, as described below, that the media signal file is compatible with.

In particular embodiments, the first portion of the media signal file may be run, as illustrated in step 212, at which point the method may end. Particular embodiments may repeat the steps of the method of FIG. 2, where appropriate. Moreover, although this disclosure describes and illustrates particular steps of the method of FIG. 2 as occurring in a particular order, this disclosure contemplates any suitable steps of the method of FIG. 2 occurring in any suitable order. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

In particular embodiments, the media signal file may be run by any hardware or software, as described below, that the media signal file is compatible with. In particular embodiments, the displaying the second portion of the resulting media signal file and the playing of the first portion of the resulting media signal file is concurrent.

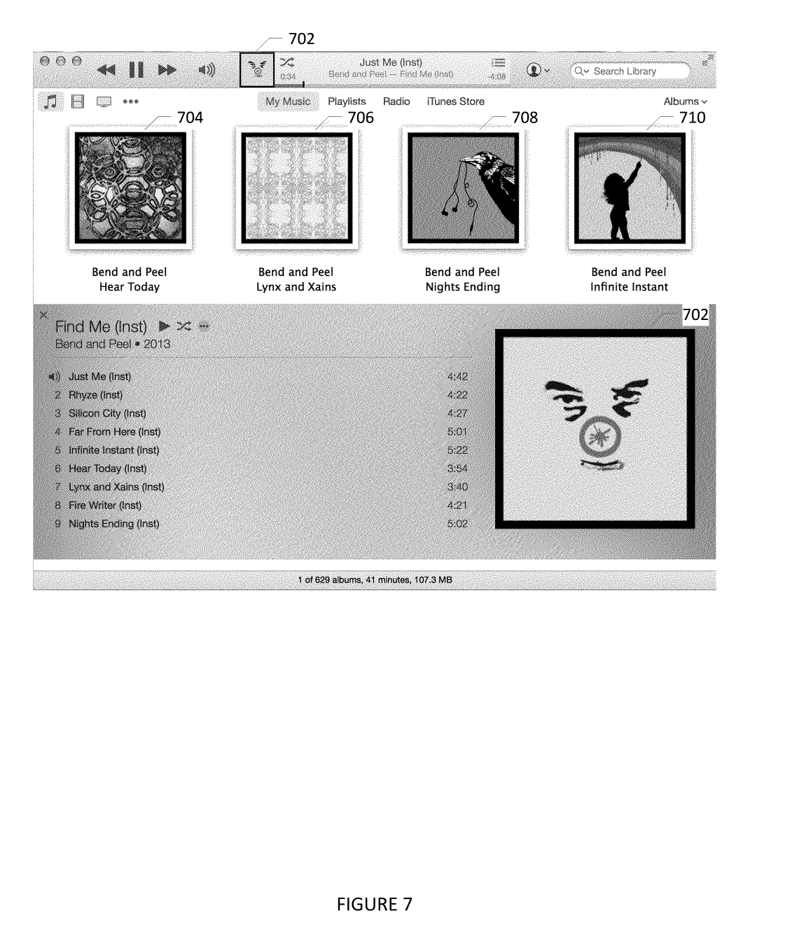

In particular example embodiments, while a song is playing, the motion cover will also be displayed, particularly as a moving image. FIG. 7 illustrates an example motion cover art during playback of a digital song. In particular embodiments, as described above, while a song is playing, a motion cover is also being displayed, and appears to be moving. In particular example embodiments, as illustrated in FIG. 7, a song entitled “Just Me (Inst)” is playing and song art 702 is also concurrently being displayed.

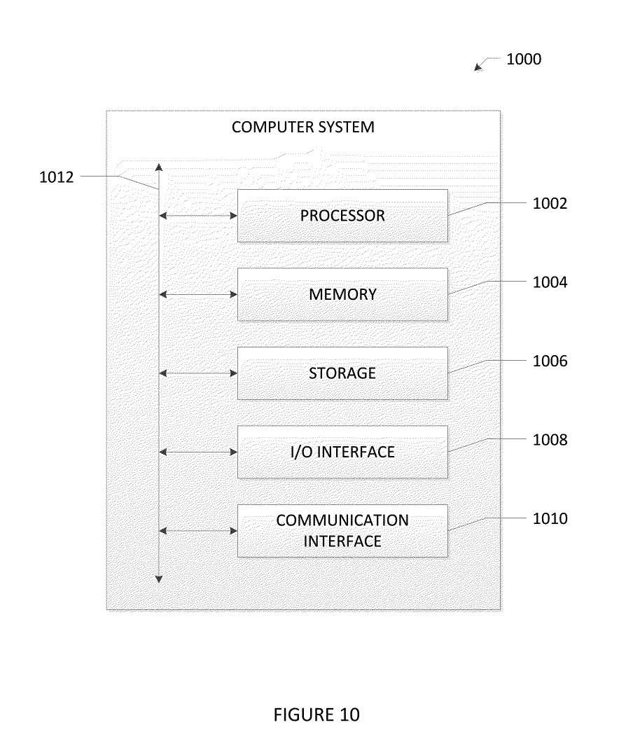

FIG. 10 illustrates an example computer system. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000.

The invention contemplates computer system 1000. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1000 may include one or more computer systems 1000; be unitary or distributed; span multiple locations; span multiple machines; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. The present invention contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. Processor 1002 may include one or more arithmetic logic units (ALUs); be a multi-core processor; or include one or more processors 1002.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 1004 may include one or more memories 1004, where appropriate.

In particular embodiments, storage 1006 includes mass storage for data or instructions. As an example and not by way of limitation, storage 1006 may include an HDD, a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006.

In particular embodiments, I/O interface 1008 includes hardware, software, or both providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. Where appropriate, I/O interface 1008 may include one or more device or software drivers enabling processor 1002 to drive one or more of these I/O devices. I/O interface 1008 may include one or more I/O interfaces 1008, where appropriate.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 1012 may include one or more buses 1012, where appropriate.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This invention contemplates one or more computer-readable storage media implementing any suitable storage. In particular embodiments, a computer-readable storage medium implements one or more portions of processor 1002 (such as, for example, one or more internal registers or caches), one or more portions of memory 1004, one or more portions of storage 1006, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language. In particular embodiments, software is expressed in ruby-on-rails, Node.js, Python, Scala, or Unity.

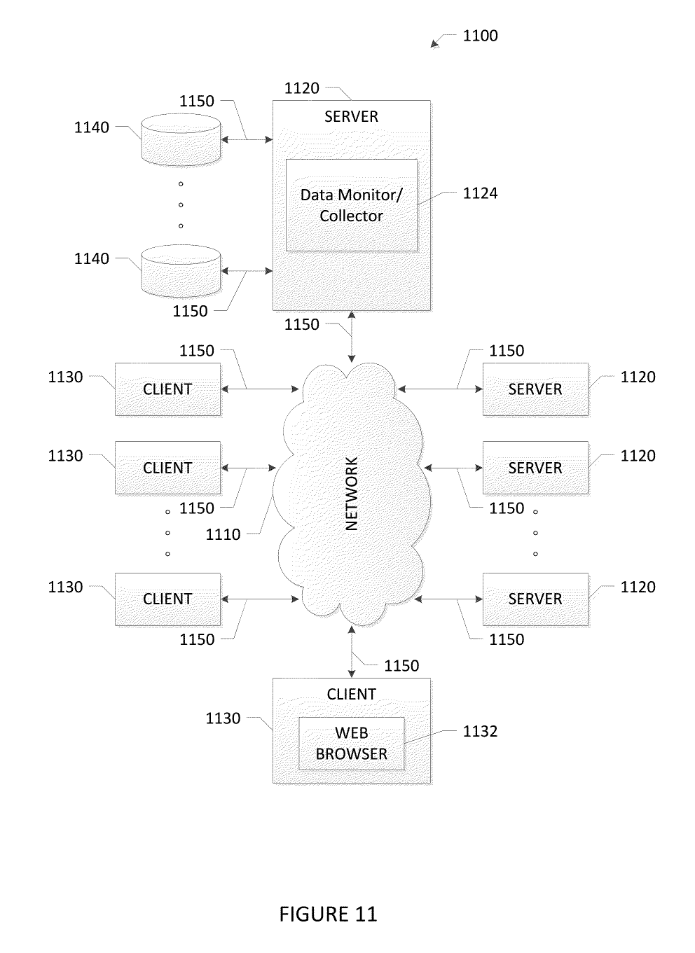

Particular embodiments may be implemented in a network environment. FIG. 11 illustrates an example network environment 1100. Network environment 1100 includes a network 1110 coupling one or more servers 1120 and one or more clients 1130 to each other. In particular embodiments, network 1110 is an intranet, an extranet, a virtual private network (VPN), a local area network (LAN), a wireless LAN (WLAN), a wide area network (WAN), a metropolitan area network (MAN), a communications network, a satellite network, a portion of the Internet, or another network 1110 or a combination of two or more such networks 1110. The present disclosure contemplates any suitable network 1110.

One or more links 1150 couple servers 1120 or clients 1130 to network 1110. In particular embodiments, one or more links 1150 each includes one or more wired, wireless, or optical links 1150. In particular embodiments, one or more links 1150 each includes an intranet, an extranet, a VPN, a LAN, a WLAN, a WAN, a MAN, a communications network, a satellite network, a portion of the Internet, or another link 1150 or a combination of two or more such links 1150. The present disclosure contemplates any suitable links 1150 coupling servers 1120 and clients 1130 to network 1110.

In particular embodiments, each server 1120 may be a unitary server or may be a distributed server spanning multiple computers or multiple datacenters. Servers 1120 may be of various types, such as, for example and without limitation, web server, news server, mail server, message server, advertising server, file server, application server, exchange server, database server, or proxy server. In particular embodiments, each server 1120 may include hardware, software, or embedded logic components or a combination of two or more such components for carrying out the appropriate functionalities implemented or supported by server 1120.

In particular embodiments, each client 1130 may be an electronic device including hardware, software, or embedded logic components or a combination of two or more such components and capable of carrying out the appropriate functionalities implemented or supported by client 1130. For example and without limitation, a client 1130 may be a desktop computer system, a notebook computer system, a netbook computer system, a handheld electronic device, or a mobile telephone. A client 1130 may enable a network user at client 1130 to access network 1110. A client 1130 may have a web browser, such as Microsoft Internet Explorer or Mozilla Firefox, and may have one or more add-ons, plug-ins, or other extension. A client 1130 may enable its user to communicate with other users at other clients 1130. The present disclosure contemplates any suitable clients 1130.

In particular embodiments, one or more data storages 1140 may be communicatively linked to one or more servers 1120 via one or more links 1150. In particular embodiments, data storages 1140 may be used to store various types of information. In particular embodiments, the information stored in data storages 1140 may be organized according to specific data structures. Particular embodiments may provide interfaces that enable servers 1120 or clients 1130 to manage (e.g., retrieve, modify, add, or delete) the information stored in data storage 1140.

In particular embodiments, a server 1120 may include a data monitor/collector 1124. Data monitor/collection 1124 may include hardware, software, or embedded logic components or a combination of two or more such components for carrying out the appropriate functionalities implemented or supported by data collector/collector 1124. For example and without limitation, data monitor/collector 1124 may monitor and collect network traffic data at server 1120 and store the collected network traffic data in one or more data storage 1140. The pairs of search query and clicked URL may then be extracted from the network traffic data.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

APPENDIX 1

| Image File Format | Description |
|---|---|
| JPEG | (Joint Photographic Experts Group) is a lossy compression method; |
| | JPEG-compressed images are usually stored in the JFIF (JPEG File |
| | Interchange Format) file format. The JPEG/JFIF filename extension |
| | is JPG or JPEG. Nearly every digital camera can save images in the |
| | JPEG/JFIF format, which supports eight-bit grayscale images and |
| | 24-bit color images (eight bits each for red, green, and blue). JPEG |
| | applies lossy compression to images, which can result in a significant |
| | reduction of the file size. Applications can determine the degree of |
| | compression to apply, and the amount of compression affects the |
| | visual quality of the result. When not too great, the compression does |
| | not noticeably affect or detract from the image's quality, but JPEG |
| | files suffer generational degradation when repeatedly edited and |
| | saved. (JPEG also provides lossless image storage, but the lossless |
| | version is not widely supported.) |
| JPEG 2000 | a compression standard enabling both lossless and lossy storage. The |
| | compression methods used are different from the ones in standard |
| | JFIF/JPEG; they improve quality and compression ratios, but also |
| | require more computational power to process. JPEG 2000 also adds |
| | features that are missing in JPEG. It is not nearly as common as |
| | JPEG, but it is used currently in professional movie editing and |
| | distribution (some digital cinemas, for example, use JPEG 2000 for |
| | individual movie frames). |
| Exif | Exchangeable image file format is a file standard similar to the .JFIF |
| | format with TIFF extensions; it is incorporated in the JPEG-writing |
| | software used in most cameras. Its purpose is to record and to |
| | standardize the exchange of images with image metadata between |
| | digital cameras and editing and viewing software. The metadata are |
| | recorded for individual images and include such things as camera |
| | settings, time and date, shutter speed, exposure, image size, |
| | compression, name of camera, color information. When images are |
| | viewed or edited by image editing software, all of this image |
| | information can be displayed. The actual Exif metadata as such may |
| | be carried within different host formats, e.g. TIFF, JFIF (JPEG) or |
| | PNG. IFF-META is another example. |
| TIFF | (Tagged Image File Format) format is a flexible format that normally |
| | saves eight bits or sixteen bits per color (red, green, blue) for 24-bit |
| | and 48-bit totals, respectively, usually using either the TIFF or TIF |
| | filename extension. The tagged structure was designed to be easily |
| | extendible, and many vendors have introduced proprietary special- |
| | purpose tags - with the result that no one reader handles every flavor |
| | of TIFF file.[citation needed]. TIFFs can be lossy and lossless; some |
| | offer relatively good lossless compression for bi-level (black&white) |
| | images. Some digital cameras can save images in TIFF format, using |
| | the LZW compression algorithm for lossless storage. TIFF image |
| | format is not widely supported by web browsers. TIFF remains |
| | widely accepted as a photograph file standard in the printing |
| | business. TIFF can handle device-specific color spaces, such as the |
| | CMYK defined by a particular set of printing press inks. OCR |
| | (Optical Character Recognition) software packages commonly |
| | generate some form of TIFF image (often monochromatic) for |
| | scanned text pages. |
| RIF | Refers to raw image formats that are available on some digital |
| | cameras, rather than to a specific format. These formats usually use a |
| | lossless or nearly lossless compression, and produce file sizes smaller |
| | than the TIFF formats. Although there is a standard raw image |
| | format, (ISO 12234-2, TIFF/EP), the raw formats used by most |
| | cameras are not standardized or documented, and differ among |
| | camera manufacturers. |
| | Most camera manufacturers have their own software for decoding or |
| | developing their raw file format, but there are also many third-party |
| | raw file converter applications available that accept raw files from |
| | most digital cameras. Some graphic programs and image editors may |
| | not accept some or all raw file formats, and some older ones have |
| | been effectively orphaned already. |
| | As far as videocameras are concerned, ARRI's Arriflex D-20 and D- |
| | 21 cameras provide raw 3K-resolution sensor data with Bayer pattern |
| | as still images (one per frame) in a proprietary format (.ari file |
| | extension). Red Digital Cinema Camera Company, with its |
| | Mysterium sensor family of still and video cameras, uses its |
| | proprietary raw format called REDCODE (.R3D extension), which |
| | stores still as well as audio + video information in one lossy- |
| | compressed file. |
| GIF | (Graphics Interchange Format) is for common usage limited to an 8- |
| | bit palette, or 256 colors (while 24-bit color depth is possible[1][2]). |
| | The GIF format is most suitable for storing graphics with few colors, |
| | such as simple diagrams, shapes, logos and cartoon style images, as it |
| | uses LZW lossless compression which is more effective when large |
| | areas have a single color, and less effective for photographic or |
| | dithered images. Due to the GIF's format simplicity and age, it |
| | achieved almost universal software support. Due to its included |
| | animation capabilities it is still widely used to provide image |
| | animation effects, despite its low compression ratio in comparison to |
| | modern video formats. |
| BMP file format | (Windows bitmap) handles graphics files within the Microsoft |
| | Windows OS. Typically, BMP files are uncompressed, and therefore |
| | large and lossless; their advantage is their simple structure and wide |
| | acceptance in Windows programs. |
| PNG | (Portable Network Graphics) file format was created as a free, open- |
| | source alternative to GIF. The PNG file format supports eight-bit |
| | paletted images (with optional transparency for all palette colors) and |
| | 24-bit truecolor (16 million colors) or 48-bit truecolor with and |
| | without alpha channel - while GIF supports only 256 colors and a |
| | single transparent color. |
| | Compared to JPEG, PNG excels when the image has large, uniformly |
| | colored areas. Even for photographs - where JPEG is often the |
| | choice for final distribution since its compression technique typically |
| | yields smaller file sizes - PNG is still well-suited to storing images |
| | during the editing process because of its lossless compression. |
| | PNG provides a patent-free replacement for GIF (though GIF is itself |
| | now patent-free), and can also replace many common uses of TIFF. |
| | Indexed-color, grayscale, and truecolor images are supported, plus an |
| | optional alpha channel. The Adam7 interlacing allows an early |
| | preview, even when only a small percentage of the image data has |
| | been transmitted. PNG can store gamma and chromaticity data for |
| | improved color matching on heterogeneous platforms. |
| | PNG is designed to work well in online viewing applications like |
| | web browsers and can be fully streamed with a progressive display |
| | option. PNG is robust, providing both full file integrity checking and |
| | simple detection of common transmission errors. |
| | Animated formats derived from PNG are MNG and APNG. The |
| | latter is supported by Mozilla Firefox and Opera and is backwards |
| | compatible with PNG. |
| PPM, PGM, PBM, and | Netpbm format is a family including the portable pixmap file format |
| PNM | (PPM), the portable graymap file format (PGM) and the portable |
| | bitmap file format (PBM). These are either pure ASCII files or raw |
| | binary files with an ASCII header that provide very basic |
| | functionality and serve as a lowest common denominator for |
| | converting pixmap, graymap, or bitmap files between different |
| | platforms. Several applications refer to them collectively as PNM |
| | (Portable aNy Map). |
| WEBP | WebP is a new open image format that uses both lossless and lossy |
| | compression. It was designed by Google to reduce image file size to |
| | speed up web page loading: its principal purpose is to supersede |
| | JPEG as the primary format for photographs on the web. WebP is |
| | based on VP8's intra-frame coding and uses a container based on |
| | RIFF. |
| HDR raster formats | Most typical raster formats cannot store HDR data (32 bit floating |
| | point values per pixel component), which is why some relatively old |
| | or complex formats are still predominant here, and worth mentioning |
| | separately. Newer alternatives are showing up, though. RGBE is the |
| | format for HDR images originating from Radiance and also |
| | supported by Adobe Photoshop. |
| BPG | (Better Portable Graphics) is a new image format. Its purpose is to |
| | replace the JPEG image format when quality or file size is an issue. |
| | Its main advantages are High compression ratio. Files are much |
| | smaller than JPEG for similar quality; Supported by most Web |
| | browsers with a small Javascript decoder (gzipped size: 76 KB); |
| | Based on a subset of the HEVC open video compression standard; |
| | Supports the same chroma formats as JPEG (grayscale, YCbCr 4:2:0, |
| | 4:2:2, 4:4:4) to reduce the losses during the conversion; An alpha |
| | channel is supported; The RGB, YCgCo and CMYK color spaces are |
| | also supported; Native support of 8 to 14 bits per channel for a higher |
| | dynamic range; Lossless compression is supported; Various meta |
| | data (such as EXIF) can be included. |
| CD5 | (Chasys Draw Image) |
| DEEP ( | IFF-style format used by TVPaint) |
| ECW | (Enhanced Compression Wavelet) |
| FITS ( | Flexible Image Transport System) |
| ILBM- | Interleaved Bitmap, used by Electronic arts |
| ILBM | (IFF-style format for up to 32 bit in planar representation, plus |
| | optional 64 bit extensions) |
| IMG | (ERDAS IMAGINE Image) |
| IMG | (Graphical Environment Manager image file; planar, run-length |
| | encoded) |
| JPEG XR | (New JPEG standard based on Microsoft HD Photo) |
| Layered Image File | for microscope image processing |
| Format | |
| Nrrd ( | Nearly raw raster data) |
| PAM | (Portable Arbitrary Map) is a late addition to the Netpbm family |
| PCX | Personal Computer eXchange |
| PGF | (Progressive Graphics File) |
| PLBM | Planar Bitmap, proprietary Amiga format |
| SGI | |
| SID | (multiresolution seamless image database, MrSID) |
| Sun Raster | |
| TGA (TARGA) | |
| VICAR file format | NASA/JPL image transport format |
| CPT | (Corel Photo Paint) |
| PSD | (Adobe PhotoShop Document) |
| PSP | (Corel Paint Shop Pro) |
| XCF | (eXperimental Computing Facility format, native GIMP format) |
| CGM | (Computer Graphics Metafile) is a file format for 2D vector graphics, |
| | raster graphics, and text, and is defined by ISO/IEC 8632. All |
| | graphical elements can be specified in a textual source file that can |
| | be compiled into a binary file or one of two text representations. |
| | CGM provides a means of graphics data interchange for computer |
| | representation of 2D graphical information independent from any |
| | particular application, system, platform, or device. It has been |
| | adopted to some extent in the areas of technical illustration and |
| | professional design, but has largely been superseded by formats such |
| | as SVG and DXF. |
| Gerber format (RS- | The Gerber format (aka Extended Gerber, RS-274X) was developed |
| 274X) | by Gerber Systems Corp., now Ucamco, and is a 2D bi-level image |
| | description format. It is the de facto standard format used by printed |
| | circuit board or PCB software. It is also widely used in other |
| | industries requiring high-precision 2D bi-level images. |
| SVG | Scalable Vector Graphics) is an open standard created and developed |
| | by the World Wide Web Consortium to address the need (and |
| | attempts of several corporations) for a versatile, scriptable and all- |
| | purpose vector format for the web and otherwise. The SVG format |
| | does not have a compression scheme of its own, but due to the |
| | textual nature of XML, an SVG graphic can be compressed using a |
| | program such as gzip. Because of its scripting potential, SVG is a |
| | key component in web applications: interactive web pages that look |
| | and act like applications. |
| AI | Adobe Illustrator |
| CDR | CorelDRAW |
| DrawingML | |
| GEM metafiles | interpreted and written by the Graphical Environment Manager VDI |
| | subsystem |
| Graphics Layout | |
| Engine | |
| HPGL, | introduced on Hewlett-Packard plotters, but generalized into a printer |
| | language |
| HVIF | Haiku Vector Icon Format |
| MathML | |
| NAPLPS | North American Presentation Layer Protocol Syntax |
| ODG | (OpenDocument Graphics) |
| !DRAW, | a native vector graphic format (in several backward compatible |
| | versions) for the RISC-OS computer system begun by Acorn in the |
| | mid-1980s and still present on that platform today |
| POV- | Ray markup language |
| PPT | (Microsoft PowerPoint) |
| Precision Graphics | |
| Markup Language | |
| PSTricks and | languages for creating graphics in TeX documents. |
| PGF/TikZ | |
| ReGIS, | used by DEC computer terminals |
| Remote imaging | |
| protocol | |
| VML | (Vector Markup Language) |
| WMF/EMF | (Windows Metafile/Enhanced Metafile) |
| Xar format | used in vector applications from Xara |
| XPS | (XML Paper Specification) |
| AMF | Additive Manufacturing File Format |
| Asymptote | A language that lifts TeX to 3D. |
| .blend | Blender |
| COLLADA | |
| .dgn | |
| .dwf | |
| .dwg | |
| .dxf | |
| eDrawings | |
| .flt | OpenFlight |
| HSF | |
| IGES | |
| IMML | Immersive Media Markup Language |
| IPA | |
| JT | |
| .MA | Maya ASCII format |
| .MB | Maya Binary format |
| .OBJ | Alias\|Wavefront file format |
| OpenGEX | Open Game Engine Exchange |
| PRC | |
| STEP | |
| SKP | |
| STL | A stereolithography format |
| U3D | Universal 3D file format |
| VRML | Virtual Reality Modeling Language |
| XAML | |
| XGL | |
| XVL | |
| xVRML | |
| X3D | |
| .3D | |
| 3DF | |
| .3DM | |
| .3ds - Autodesk 3D | |
| Studio | |
| 3DXML | |
| X3D - Vector format | |
| used in 3D | |
| applications from Xara | |
| EPS | (Encapsulated PostScript) |
| PDF | (Portable Document Format) |
| PostScript | a page description language with strong graphics capabilities |
| PICT | (Classic Macintosh QuickDraw file) |
| SWF | (Shockwave Flash) |
| XAML | User interface language using vector graphics for images. |
| MPO | The Multi Picture Object (.mpo) format consists of multiple JPEG |
| | images (Camera & Imaging Products Association) (CIPA). |
| PNS | The PNG Stereo (.pns) format consists of a side-by-side image based |
| | on PNG (Portable Network Graphics). |
| JPS | The JPEG Stereo (.jps) format consists of a side-by-side image |
| | format based on JPEG. |

APPENDIX 2

| File | Creation | |
|---|---|---|
| Extension | Company | Description |
| .3gp | | multimedia container format can contain proprietary |
| | | formats as AMR, AMR-WB or AMR-WB+, but also |
| | | some open formats |
| .act | | ACT is a lossy ADPCM 8 kbit/s compressed audio |
| | | format recorded by most Chinese MP3 and MP4 |
| | | players with a recording function, and voice recorders |
| .aiff | Apple | standard audio file format used by Apple. It could be |
| | | considered the Apple equivalent of wav. |
| .aac | | the Advanced Audio Coding format is based on the |
| | | MPEG-2 and MPEG-4 standards. aac files are usually |
| | | ADTS or ADIF containers. |
| .amr | | AMR-NB audio, used primarily for speech. |
| .au | Sun Microsystems | the standard audio file format used by Sun, Unix and |
| | | Java. The audio in au files can be PCM or |
| | | compressed with the μ-law, a-law or G729 codecs. |
| .awb | | AMR-WB audio, used primarily for speech, same as |
| | | the ITU-T's G.722.2 specification. |
| .dct | NCH Software | A variable codec format designed for dictation. It has |
| | | dictation header information and can be encrypted (as |
| | | may be required by medical confidentiality laws). A |
| | | proprietary format of NCH Software. |
| .dss | Olympus | dss files are an Olympus proprietary format. It is a |
| | | fairly old and poor codec. Gsm or mp3 are generally |
| | | preferred where the recorder allows. It allows |
| | | additional data to be held in the file header. |
| .dvf | Sony | a Sony proprietary format for compressed voice files; |
| | | commonly used by Sony dictation recorders. |
| .flac | | File format for the Free Lossless Audio Codec, a |
| | | lossless compression codec. |
| .gsm | | designed for telephony use in Europe, gsm is a very |
| | | practical format for telephone quality voice. It makes |
| | | a good compromise between file size and quality. |
| | | Note that wav files can also be encoded with the gsm |
| | | codec. |
| .iklax | iKlax | An iKlax Media proprietary format, the iKlax format |
| | | is a multi-track digital audio format allowing various |
| | | actions on musical data, for instance on mixing and |
| | | volumes arrangements. |
| .ivs | 3D Solar UK Ltd | A proprietary version with Digital Rights |
| | | Management developed by 3D Solar UK Ltd for use |
| | | in music downloaded from their Tronme Music Store |
| | | and interactive music and video player. |
| .m4a | | An audio-only MPEG-4 file, used by Apple for |
| | | unprotected music downloaded from their iTunes |
| | | Music Store. Audio within the m4a file is typically |
| | | encoded with AAC, although lossless ALAC may |
| | | also be used. |
| .m4p | Apple | A version of AAC with proprietary Digital Rights |
| | | Management developed by Apple for use in music |
| | | downloaded from their iTunes Music Store. |
| .mmf | Samsung | a Samsung audio format that is used in ringtones. |
| .mp3 | | MPEG Layer III Audio. Is the most common sound |
| | | file format used today. |
| .mpc | | Musepack or MPC (formerly known as MPEGplus, |
| | | MPEG+ or MP+) is an open source lossy audio |
| | | codec, specifically optimized for transparent |
| | | compression of stereo audio at bitrates of 160-180 kbit/s. |
| .msv | Sony | a Sony proprietary format for Memory Stick |
| | | compressed voice files. |
| .ogg, .oga | Xiph.Org | a free, open source container format supporting a |
| | Foundation | variety of formats, the most popular of which is the |
| | | audio format Vorbis. Vorbis offers compression |
| | | similar to MP3 but is less popular. |
| .opus | Internet | a lossy audio compression format developed by the |
| | Engineering Task | Internet Engineering Task Force (IETF) and made |
| | Force | especially suitable for interactive real-time |
| | | applications over the Internet. As an open format |
| | | standardised through RFC 6716, a reference |
| | | implementation is provided under the 3-clause BSD |
| | | license. |
| .ra, .rm | RealNetworks | a RealAudio format designed for streaming audio |
| | | over the Internet. The .ra format allows files to be |
| | | stored in a self-contained fashion on a computer, with |
| | | all of the audio data contained inside the file itself. |
| .raw | | a raw file can contain audio in any format but is |
| | | usually used with PCM audio data. It is rarely used |
| | | except for technical tests. |
| .sln | | Signed Linear PCM format used by Asterisk. Prior to |
| | | v.10 the standard formats were 16-bit Signed Linear |
| | | PCM sampled at 8 kHz and at 16 kHz. With v.10 many |
| | | more sampling rates were added. |
| .tta | | The True Audio, real-time lossless audio codec. |
| .vox | | the vox format most commonly uses the Dialogic |
| | | ADPCM (Adaptive Differential Pulse Code |
| | | Modulation) codec. Similar to other ADPCM |
| | | formats, it compresses to 4-bits. Vox format files are |
| | | similar to wave files except that the vox files contain |
| | | no information about the file itself so the codec |
| | | sample rate and number of channels must first be |
| | | specified in order to play a vox file. |
| .wav | | standard audio file container format used mainly in |
| | | Windows PCs. Commonly used for storing |
| | | uncompressed (PCM), CD-quality sound files, which |
| | | means that they can be large in size - around 10 MB |
| | | per minute. Wave files can also contain data encoded |
| | | with a variety of (lossy) codecs to reduce the file size |
| | | (for example the GSM or MP3 formats). Wav files |
| | | use a RIFF structure. |
| .wma | Microsoft | Windows Media Audio format, created by Microsoft. |
| | | Designed with Digital Rights Management (DRM) |
| | | abilities for copy protection. |
| .wv | | format for wavpack file |
| | | http://www.wavpack.com/flash/wavpack.htm |
| .webm | | Royalty-free format created for HTML5 video. |

APPENDIX 3

| | File | | Video Coding | Audio Coding |
|---|---|---|---|---|
| Name | Extension | Container | Format(s) | Format(s) |
| WebM | .webm | Matroska | VP8, VP9 | Vorbis, Opus |
| Matroska | .mkv | Matroska | Any | Any |
| Flash Video | .flv | FLV | VP6, Sorenson | MP3, ADPCM, |
| (FLV) | | | Spark, Screen | Nellymoser, Speex, |
| | | | video, Screen | AAC |
| | | | video 2, H.264 | |
| F4V | .flv | MPEG-4 Part 12 | H.264 | MP3, AAC |
| Vob | .vob | VOB | H.262/MPEG-2 | PCM, DTS, MPEG-1, |
| | | | Part 2 or MPEG-1 | Audio Layer II (MP2), |
| | | | Part 2 | or Dolby Digital (AC- |
| | | | | 3)[ |
| Ogg Video | .ogv, .ogg | Ogg | Theora, Dirac | Vorbis, FLAC |
| Dirac | .drc | | Dirac | |
| Multiple- | .mng | N/A | N/A | none |
| image | | | | |
| Network | | | | |
| Graphics | | | | |
| AVI | .avi | AVI | any | any |
| QuickTime | .mov, .qt | Quicktime | Many | AAC, MP3, others |
| File Format | | | | |
| Windows | .wmv | ASF | Windows Media | Windows Media Audio, |
| Media Video | | | Video, Windows | Sipro ACELP.net |
| | | | Media Video | |
| | | | Screen, Windows | |
| | | | Media Video | |
| | | | Image | |
| Raw video | .yuv | Further | Doesn't apply | Doesn't apply |
| format | | documentation | | |
| | | needed | | |
| RealMedia | .rm | RealMedia | RealVideo | RealAudio |
| (RM) | | | | |
| RealMedia | .rmvb | RealMedia | RealVideo | RealAudio |
| Variable | | Variable Bitrate | | |
| Bitrate | | | | |
| (RMVB) | | | | |
| Advanced | .asf | ASF | any | any |
| Systems | | | | |
| Format (ASF) | | | | |
| MPEG-4 Part | .mp4, | MPEG-4 Part 12 | H.264, MPEG-4 | Advanced Audio |
| 14 (MP4) | .m4p | | Part 2, MPEG-2, | Coding, MP3, others |
| | (with | | MPEG-1 | |
| | DRM), | | | |
| | .m4v | | | |
| MPEG-1 | .mpg, | MPEG-1 part 1 | MPEG-1 part 2 | MPEG-1 Audio Layer I, |
| | .mp2, | | | MPEG-1 Audio Layer I, |
| | .mpeg, | | | MPEG-1 Audio Layer |
| | .mpe, | | | III (MP3) |
| | .mpv | | | |
| MPEG-2 - | .mpg, | | H.262 | AAC, MP3, MPEG-2 |
| Video | .mpeg, | | | Part 3, others |
| | .m2v | | | |
| M4V - (file | .m4v | MPEG-4 Part 12 | H.264 | AAC, Dolby Digital |
| format for | | | | |
| videos for | | | | |
| iPods and | | | | |
| PlayStation | | | | |
| Portables | | | | |
| developed by | | | | |
| Apple) | | | | |
| SVI | .svi | | | |
| 3GPP | .3gp | MPEG-4 Part 12 | MPEG-4 Part 2, | AMR-NB, AMR-WB, |
| | | | H.263, H.264 | AMR-WB+, AAC-LC, |
| | | | | HE-AAC v1 or |
| | | | | Enhanced aacPlus (HE- |
| | | | | AAC v2) |
| 3GPP2 | .3g2 | MPEG-4 Part 12 | MPEG-4 Part 2, | AMR-NB, AMR-WB, |
| | | | H.263, H.264 | AMR-WB+, AAC-LC, |
| | | | | HE-AAC v1 or |
| | | | | Enhanced aacPlus (HE- |
| | | | | AAC v2), |
| | | | | EVRCVocoder\|SMV]] |
| | | | | or VMR-WB |
| Material | .mxf | MXF | | |
| Exchange | | | | |
| Format | | | | |
| (MXF) | | | | |
| ROQ | .roq | | | |
| Nullsoft | .nsv | NSV | | |
| Streaming | | | | |
| Video (NSV) | | | | |

1. A method comprising:
receive, by a computing device, a resulting media signal file comprising a first portion of a media signal file associated with a second portion of another media signal file, the first portion of the media signal file comprising an audio track and the second portion of the another media signal file comprising one or more frames of a graphic art image;
extract, by the computing device, the second portion of the resulting media signal file;
display, by the computing device, the second portion of the resulting media signal file, wherein the one or more frames of the graphic art image stream in a first sequence and the one or more frames of the graphic art image appear to be moving;
extract, by the computing device, the first portion of the resulting media signal file;
run, by the second computing device, the first portion of the resulting media signal file, wherein the displaying of the second portion of the resulting media signal file and the running of the first portion of the resulting media signal file are concurrent; and
display, by the computing device, a repeating sequence of the second portion of the media signal file when the first sequence of the one or more frames of the graphic art is completed.

2. The method of claim 1, wherein:
the first portion of the media signal file comprising an audio track comprising an audio file format; and
the second portion of the another media signal file comprising at least one of an image file format and a video file format.

3. The method of claim 1, wherein the resulting media signal file comprising a file type comprising both an audio and video file.

4. The method of claim 1, wherein:
the first portion of the media signal file comprising an audio track comprising an audio file format; and
the second portion of the another media signal file one or more frames of a graphic art image comprising metadata.

5. The method of claim 3, wherein the resulting media file comprising a .mov file.

6. The method of claim 1, wherein the second computing device is coupled to at least one of an album, CD, DVD, BluRay, book, and video game.

7. The method of claim 4, wherein the audio file format comprises at least one of .mp3 and .aac.

8. A system comprising:
one or more processors of a computing device; and
a memory coupled to the processors comprising instructions executable by the processors, the processors of the computing device being operable when executing the instructions to:
receive a resulting media signal file comprising a first portion of a media signal file associated with a second portion of another media signal file, the first portion of the media signal file comprising an audio track and the second portion of the another media signal file comprising one or more frames of a graphic art image;
extract the second portion of the resulting media signal file;
display the second portion of the resulting media signal file, wherein the one or more frames of the graphic art image stream in a first sequence and the one or more frames of the graphic art image appear to be moving;
extract the first portion of the resulting media signal file;
run the first portion of the resulting media signal file, wherein the displaying of the second portion of the resulting media signal file and the running of the first portion of the resulting media signal file are concurrent; and
display a repeating sequence of the second portion of the media signal file when the first sequence of the one or more frames of the graphic art is completed.

9. The system of claim 8, wherein:
the first portion of the media signal file comprising an audio track comprising an audio file format; and
the second portion of the another media signal file comprising at least one of an image file format and a video file format.

10. The system of claim 8, wherein the resulting media signal file comprising a file type comprising both an audio and video file.

11. The system of claim 8, wherein:
the first portion of the media signal file comprising an audio track comprising an audio file format; and
the second portion of the another media signal file one or more frames of a graphic art image comprising metadata.

12. The system of claim 8, wherein the resulting media file comprising a .mov file.

13. The system of claim 8, wherein the second computing device is coupled to at least one of an album, CD, DVD, BluRay, book, and video game.

14. The system of claim 11, wherein the audio file format comprises at least one of .mp3 and .aac.

15. One or more computer-readable non-transitory storage media embodying software that is operable when executed to:
receive a resulting media signal file comprising a first portion of a media signal file associated with a second portion of another media signal file, the first portion of the media signal file comprising an audio track and the second portion of the another media signal file comprising one or more frames of a graphic art image;
extract the second portion of the resulting media signal file;
display the second portion of the resulting media signal file, wherein the one or more frames of the graphic art image stream in a first sequence and the one or more frames of the graphic art image appear to be moving;
extract the first portion of the resulting media signal file;
run the first portion of the resulting media signal file, wherein the displaying of the second portion of the resulting media signal file and the running of the first portion of the resulting media signal file are concurrent; and
display a repeating sequence of the second portion of the media signal file when the first sequence of the one or more frames of the graphic art is completed.

16. The media of claim 15, wherein:
the first portion of the media signal file comprising an audio track comprising an audio file format; and
the second portion of the another media signal file comprising at least one of an image file format and a video file format.

17. The media of claim 15, wherein the resulting media signal file comprising a file type comprising both an audio and video file.

18. The media of claim 15, wherein:
the first portion of the media signal file comprising an audio track comprising an audio file format; and
the second portion of the another media signal file one or more frames of a graphic art image comprising metadata.

19. The media of claim 15, wherein the resulting media file comprising a .mov file.

20. The media of claim 15, wherein the second computing device is coupled to at least one of an album, CD, DVD, BluRay, book, and video game.
